(19) United States
(12) Patent Application Publication
(10) Pub. No.: US 2005/0257061 A1
(43) Pub. Date: Nov. 17, 2005

(54) Platform and method for authenticating emails on the internet

(76) Inventor: Kuo Mei-Yin, Taichung City (TW)

Correspondence Address: CHARLES E. BAXLEY, ESQ., 90 JOHN STREET, THIRD FLOOR, NEW YORK, NY, 10038, US

(21) Appl. No.: 10/843,548

(22) Filed: May 10, 2004

(51) Int. Cl. H04L 9/00

(52) U.S. Cl. 713/176

(57) ABSTRACT

A platform and a method for authenticating email, wherein the unauthenticated advertisements/mails enter in a feedback authentication system via a screening and authentication system to determine the legality, the feedback authentication system will request the advertiser to login to be authenticated, and then send the signature to the advertiser on the condition that the advertiser meets the conditions of the feedback authentication system, Therefore, the users can receive the expected legal advertisements and the advertisers can send advertisements to the most valuable users, meanwhile, the illegal advertisements and mails on the internet can be deleted. Thereby, the present invention is a legal, effective and double-win platform and method for authenticating Emails.

### BACKGROUND OF THE INVENTION

1. Field of the Invention

The present invention relates to a platform and a method for authenticating email, wherein the unauthenticated advertisements/mails enter in a feedback authentication system via a screening and authentication system to determine the legality, the feedback authentication system will request the advertiser to login to be authenticated, and then send the signature to the advertiser on the condition that the advertiser meets the conditions of the feedback authentication system, Therefore, the users can receive the expected legal advertisements and the advertisers can send advertisements to the most valuable users, meanwhile, the illegal advertisements and mails on the internet can be deleted. Thereby, the present invention is a legal, effective and double-win platform and method for authenticating Emails.

2. Description of the Prior Arts

The email technology has been changing constantly, while the methods of Internet advertising and Internet business are also developing rapidly. Since the advertising effect via email is better than web banner, and the email advertising is relatively low cost, the electronic direct mail marketing (E-DM) has become the most popular marketing method in the internet business today. However, the conventional email advertising has still has some disadvantages, and the disadvantages can be divided into advertiser side and the recipient side:

The recipient's side:

First, although the email advertising is convenient and low cost, it will probably result in a horrible problem of Spam email due to the advertiser send out mass email advertisings, the recipient has to spend a lot of time receiving and reading the emails.

Second, to block the mass advertisements and unwanted emails, the recipient has to spend money on software of anti-spam, and spend time and computer efficiency running the anti-spam software.

Third, the software of anti-spam blocks the spam by title (including the Outlook Express) and setting the count No. of some unwanted advertisers. However, this method not only requires the user to update the screening conditions frequently, but also it is unable to block the spams whose screening conditions has not been set yet.

The advertiser's side:

First, although the email advertising is convenient and low cost, the advertiser is unable to send the email advertising aiming at the most valuable recipients, so it is low efficient and wastes the cost.

Second, to increase the circulation, the advertiser has to spend money illegally purchasing the recipient's account number.

Third, the software often block the illegal mails together with the valuable advertisements/mails, thus both the advertiser side and the recipient side need a common and concerted standard, so as to prevent the valuable advertisements/mails from being deleted.

The present invention has arisen to mitigate and/or obviate the afore-described above-mentioned disadvantages.

### SUMMARY OF THE INVENTION

The primary object of the present invention is to provide an legal, effective and double-win platform and method for authenticating email on internet, wherein a screening authentication system classify the advertisements/mails into signed advertisements/mails and unsigned advertisements/mails, the signed advertisements/mails enter a recipient condition database and to be re-screened, and the unsigned advertisements/mails enter a feedback authentication system to determine the legality. The feedback authentication system will request the advertiser to login and to be authenticated. And then send the signature to the advertiser on the condition that the advertiser meets the conditions of the feedback authentication system. Therefore, the users can receive the expected legal advertisements and the advertisers can send advertisements to the most valuable users, meanwhile, the illegal advertisements and mails on the internet can be deleted. Thereby, the present invention is a legal, effective and double-win platform and method for authenticating Emails.

The secondary object of the present invention is to provide a flexible platform and method for authenticating email on the internet. Since the present invention sets an authentication platform between the advertiser and the recipient (software or hardware mode), the authentication platform for emails can cooperate with many more application functions, such as: anti-virus, advertising bonus accumulation, toll collection, internet newspaper, monitoring function and the likes.

The platform and method for authenticating email on the internet in accordance with the present invention is capable of providing: 1) a complete service process 2) relative interactive manners during the service process 3) application of electronic signature. The present invention can cooperate with the software on the user's hardware, the ISP's soft/hard ware or other conventional software or hardware. The method of authenticating email on the internet is generally explained as follows:
classifying advertisements/mails into authenticated advertisements/mails and unauthenticated advertisements/mails with an screening authentication system, the authenticated advertisements/mails are re-screened and then sent out after entering an recipient condition database, and the unauthenticated advertisements/mails are sent to the feedback authentication system to determine the legality, the feedback authentication system authenticating the registration of the advertiser and then instructing the signature system to send the signature to the advertiser on the condition that the advertiser meets the conditions of the feedback authentication system, in this way, the recipient can receive expected legal and signed advertisements/mails, and the advertiser is able to send the signed advertisements/mails to the most valuable users.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is a schematic illustration view of the platform for authenticating email on the internet in accordance with the present invention;

FIG. 2 is a flow chart for illustrating the method for authenticating email on the internet in accordance with the present invention;

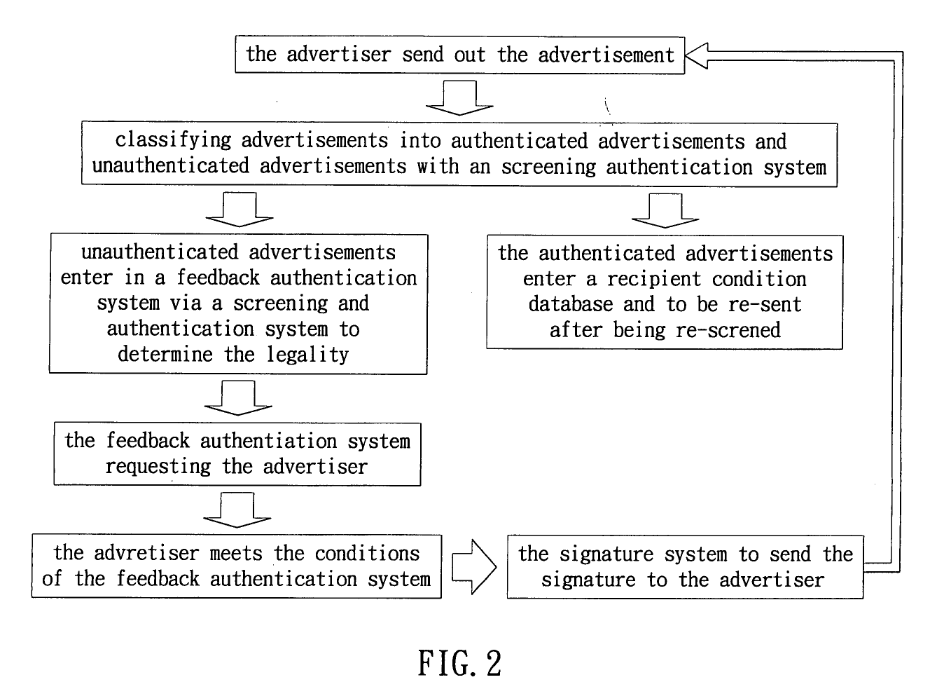

FIG. 3 shows a first embodiment in accordance with the present invention;

FIG. 4 shows a second embodiment in accordance with the present invention;

FIG. 5 shows a third embodiment in accordance with the present invention;

FIG. 6 shows a fourth embodiment in accordance with the present invention.

### DETAILED DESCRIPTION OF THE PREFERRED EMBODIMENTS

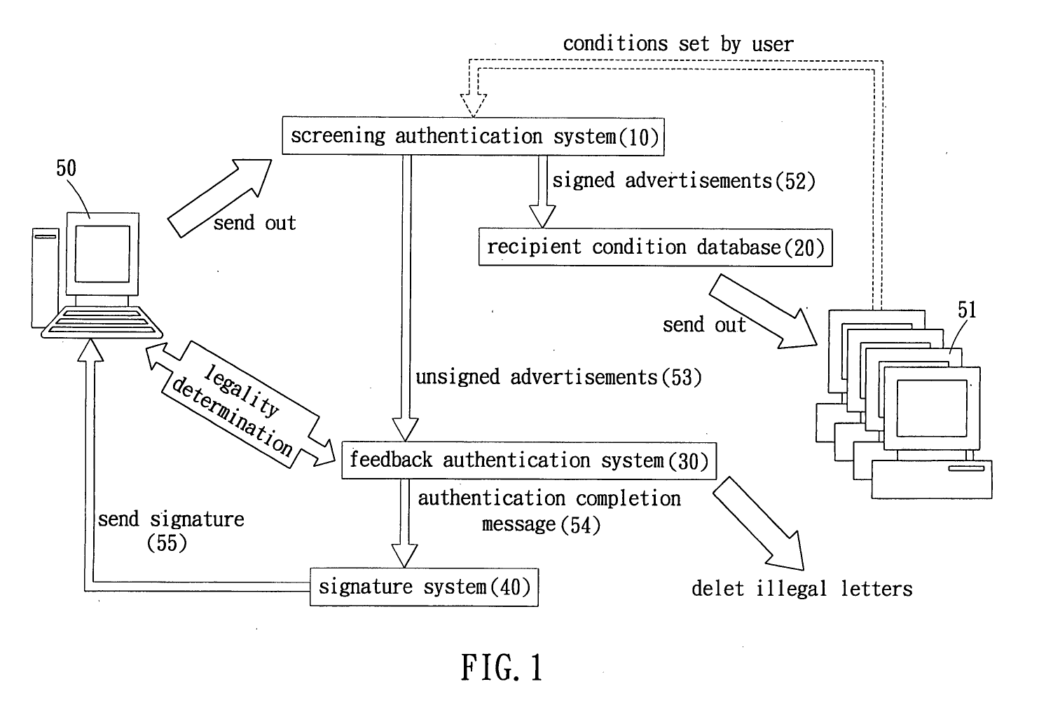

Referring to FIG. 1, a platform for authenticating email in accordance with one aspect of the present invention includes a screening authentication system 10, a recipient condition database 20, a feedback authentication system 30 and a signature system 40, which is set between the advertiser 50 and the mass recipient 51.

The screening authentication system 10 serves to receive the advertisements and mails from the advertiser 50, and then classify them into signed advertisements 52 and unsigned advertisements 53.

The recipient condition database 20 is the conditions set by the recipient 51 for further screening the advertisements, which is connected to the screening authentication system 10 and serves to receive the signed advertisements 52. The recipient condition database 20 further screens the signed advertisements 52 according to the conditions set by the recipient 51 and then send the qualified signed advertisements 52 to the recipient 51.

The feedback authentication system 30 is connected to the authentication system 10 and serves to receive the unsigned advertisements 53 screened by the authentication system 10. The feedback authentication system 30 initially deletes the illegal unsigned advertisements 53 then advises the advertiser 50 to authenticate the rest advertisements 53 respectively and synchronously sends out an authentication completion message 54.

The signature system 40 is connected to the feedback authentication system 30, which serves to receive the authentication completion message 54 sent from the feedback authentication system 30 and send signature 55 to the advertiser 50 based on the authentication completion message 54.

In the above-mentioned embodiment, the signed advertisements 52 and the unsigned advertisements 53 are explained for exemplary purpose only, however, the present invention also can be used to authenticate the general emails and mass e-mails, further explanations are omitted here.

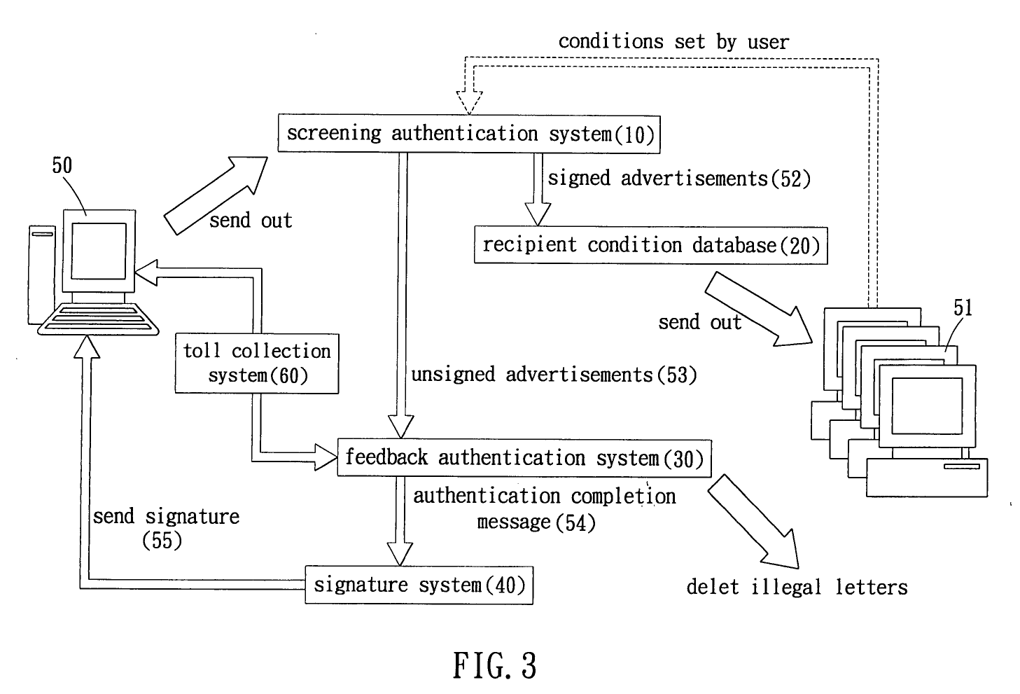

As concerns the method for authenticating the e-mails in accordance with the present invention, please refer to FIGS. 1 and 3.

Wherein the signed advertisements 52 and the unsigned advertisements 53 are sent out from the advertiser 50 and then to be classified by the screening authentication system 10. After that, the signed advertisements 52 are sent to and re-screened by the recipient condition database 20 based on the conditions set by the recipient 51, and then the signed advertisements 52 are sent to the recipient 51 while the unsigned advertisements 53 are sent to the feedback authentication system 30 to determine the legality. The feedback authentication system 30 will request the advertiser 50 to login to be authenticated. After the advertiser 50 submitted a preset authentication application to the feedback authentication system 30, the feedback authentication system 30 will instruct the signature system 40 to send the signature 55 to the advertiser 50. And then the advertiser 50 resends the signed advertisements 52. In this way, the recipient 51 can receive the expected legal and signed advertisement 52, and the advertiser 50 is able to send the signed advertisement 52 to the most valuable users. Therefore, the users can receive the expected legal advertisements and the advertisers can send advertisements to the most valuable users, meanwhile, the illegal advertisements and mails on the internet can be deleted. Thereby, the present invention is a legal, effective and double-win platform and method for authenticating Emails.

It is to be noted that the applications in accordance with the present invention are very flexible, since the present invention sets authentication platform for E-mails between the advertiser and the recipient (whatever in software or hardware mode), the authentication platform for emails can cooperate with many more application functions, which are to be explained as follows:

As shown in FIG. 3, which is the first embodiment in accordance with the present invention, wherein a toll collection system 60 is set between the feedback authentication system 30 and the advertiser 50 as an authentication condition. The feedback will send the signature 55 to the advertiser 50 after the toll collection system 60 receive the payment. Thereby the platform for authenticating email in accordance with the present invention can be operated for profit.

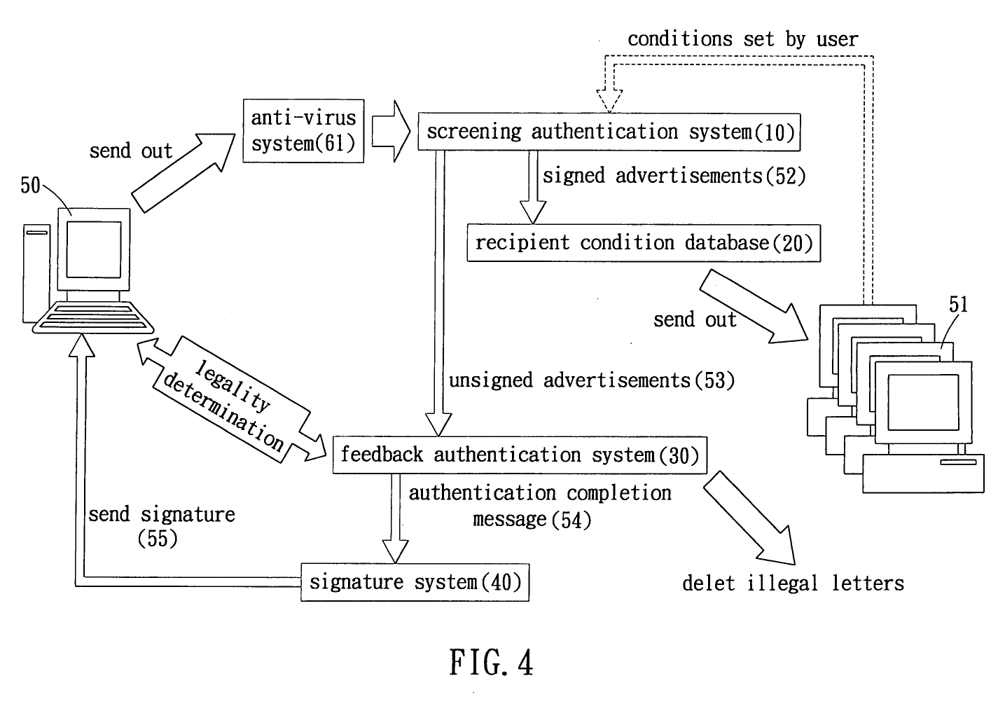

Referring to FIG. 4, which shows a second embodiment in accordance with the present invention, wherein an anti-virus system 61 can be additionally set before the screening authentication system 10, the recipient condition database 20 and the feedback authentication system 30, which can be used to filter the virus-infected signed advertisements 52 and the unsigned advertisements 53 for the recipient 51.

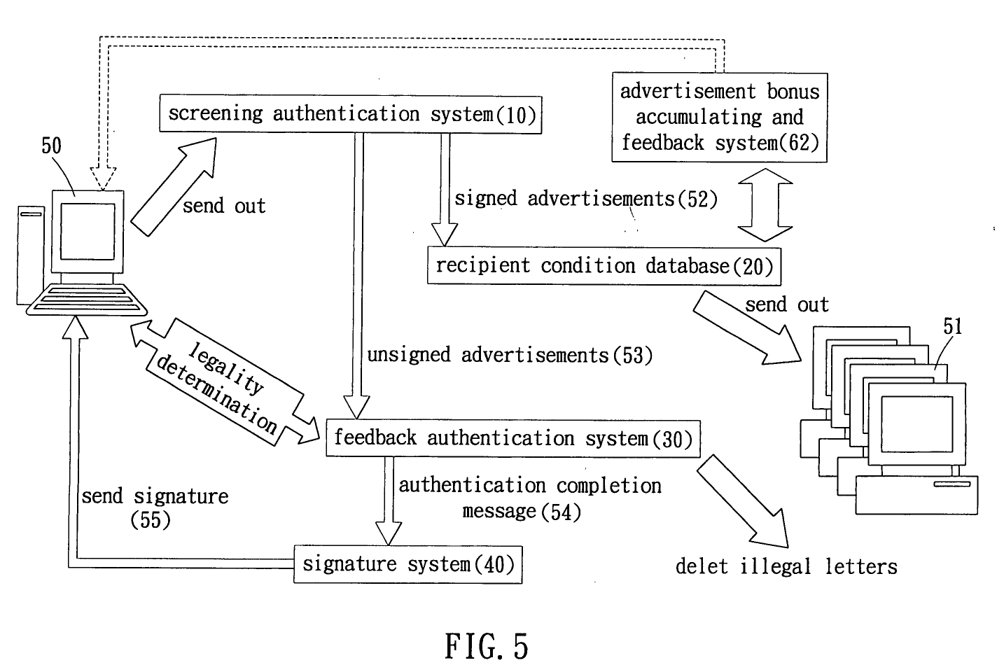

Referring to FIG. 5, which is a third embodiment in accordance with the present invention, wherein the recipient condition database 20 is additionally connected with an advertisement bonus accumulating and feedback system 62 which can provide the advertiser 50 the message of those recipients 50 who keep receiving the advertisements, and accordingly the advertiser 50 can accumulate bonus for the brand advertisement fans and feedback them.

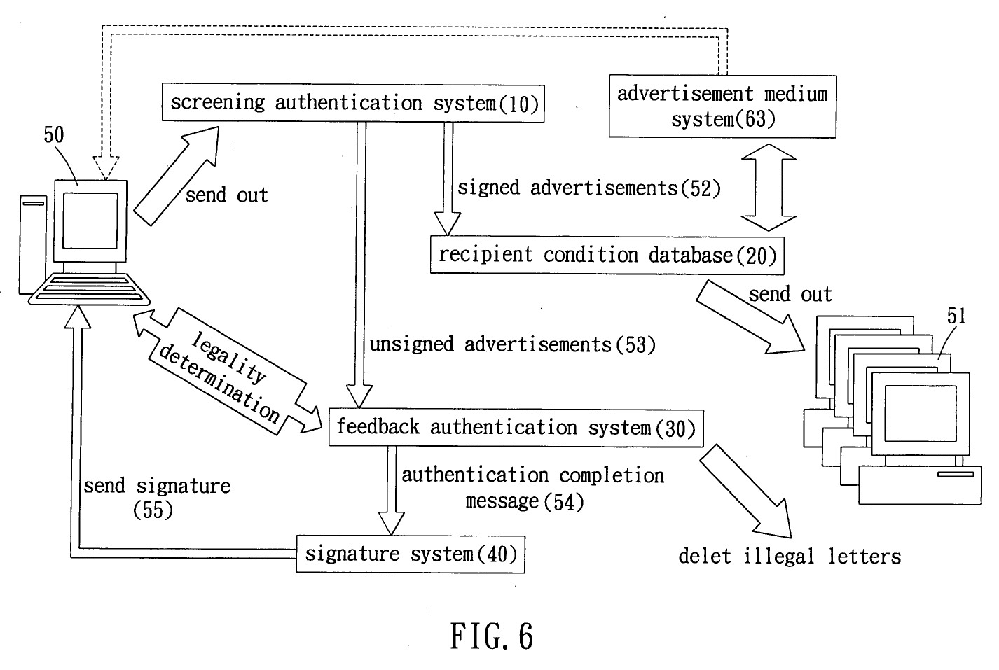

Referring further to FIG. 6, which is a third embodiment in accordance with the present invention, by cooperating with the data accumulated in the recipient condition database 20, an advertisement medium system 63 is able to positively recommend the valuable recipients 51 to the advertisement 50 on the basis of the recipient's hobby, so as to much improve the effect of advertising for the advertiser 50.

Here are another three embodiments in accordance with the present invention, which are only explained in words as follows:

First, the present invention has a both-ends monitoring function, since the present invention is set between the recipient and the sender, the system in accordance with the present invention is able to trace the location from where the advertisements/mails are sent and the destination that the advertisements/mails are sent to. Through this way, a monitoring function at both-ends is achieved, and the data of both sides can be stored as confidential in the servo of platform system.

Second, on the basis of the data of the exchanges of the emails and the advertisements, and the signature system, the present invention can record relative information about the sender and store it in the database of the platform system. Thus, the senders and the recipients can search the open data in the database.

Third, the present invention can cooperate with other manners of internet marketing and advertising. For example, it can be applied to an electronic advertisement-issuing website, so as to provide the sender and the recipient an improved mail management function, such as advertisement/mail issuing system, newspaper subscription system, such that the user is able to subscribe the newspaper via the platform in accordance with the present invention.

While we have shown and described various embodiments in accordance with the present invention, it should be clear to those skilled in the art that further embodiments may be made without departing from the scope of the present invention.

1. A platform for authenticating emails set on the internet and located between advertiser and recipient, which comprising:
a screening authentication system serving to receive advertisements/mails sent from the advertiser, and classifying the advertisements/mails into signed advertisements/mails and unsigned advertisements/mails;
a recipient condition database having conditions set by the recipient for screening the advertisements/mails, which connected to the screening authentication system and serving to receive the signed advertisements/mails from the screening authentication system, the recipient condition database screening the signed advertisements/mails according to the conditions set by the recipient and sending the authorized and signed advertisements/mails to the recipient;
a feedback authentication system connected to the screening authentication system and serving to receive the unsigned advertisements/mails screened by the screening authentication system, the feedback authentication system initially deleting illegal unsigned advertisements/mails then advising the advertiser to authenticate other unsigned advertisements/mails respectively and synchronously sending out an authentication completion message;
a signature system connected to the feedback authentication system and serving to receive the authentication completion message sent from the feedback authentication system and sending signature to the advertiser based on the authentication completion message.

2. The platform for authenticating emails as claimed in claim 1, wherein a toll collection system is set between the feedback authentication system and the advertiser as an authentication condition, the feedback will send the signature to the advertiser after the toll collection system receive payment, such that the platform for authenticating email in accordance with the present invention can be operated for profit.

3. The platform for authenticating emails as claimed in claim 1, wherein an anti-virus system can be set before the screening authentication system, which can be used to filter virus-infected signed advertisements/mails and unsigned advertisements/mails for the recipient.

4. The platform for authenticating emails as claimed in claim 1, wherein an anti-virus system can be set after the screening authentication system, which can be used to filter virus-infected signed advertisements/mails and unsigned advertisements/mails for the recipient.

5. The platform for authenticating emails as claimed in claim 1, wherein the recipient condition database is additionally connected with an advertisement bonus accumulating and feedback system which can provide the advertiser information about the advertisements/mails receiving condition of the recipients which is stored in the recipient condition database, and accordingly the advertiser can accumulate bonus and feedback the recipient.

6. The platform for authenticating emails as claimed in claim 1, wherein an advertisement medium system, by cooperating with data accumulated in the recipient condition database, is used to positively recommend the recipient to the advertiser on the basis of the information about the advertisements/mails receiving condition of the recipient.

7. A method for authenticating emails:
classifying advertisements/mails into authenticated advertisements/mails and unauthenticated advertisements/mails with an screening authentication system, the authenticated advertisements/mails are re-screened and then sent out after entering an recipient condition database, and the unauthenticated advertisements/mails are sent to the feedback authentication system to determine the legality, the feedback authentication system requesting the advertiser to login to be authenticated and then instructing the signature system to send the signature to the advertiser on the condition that the advertiser meets the conditions of the feedback authentication system, in this way, the recipient can receive expected legal and signed advertisements/mails, and the advertiser is able to send the signed advertisements/mails to the most valuable users.

8. The method for authenticating emails as claimed in claim 7 is used on software and hardware of the recipient side.

9. The method for authenticating emails as claimed in claim 7 is used on the ISP's (internet service provider) software and hardware.

10. The method for authenticating emails as claimed in claim 7, wherein the screening authentication system serves to monitor the processing between the advertiser and the recipient, so as to trace the location from where the advertisements/mails are sent and the destination that the advertisements/mails are sent to.

11. The method for authenticating emails as claimed in claim 7, wherein the screening authentication system records relative information and actions of the advertiser and store them in database of platform system for the advertiser's and the recipient's inquiry.

12. The method for authenticating emails as claimed in claim 7, wherein the method for authenticating emails can cooperate with an electronic advertising website for providing internet newspaper with management function.
